(19) United States
(12) Patent Application Publication
(10) Pub. No.: US 2024/0339899 A1
(43) Pub. Date: Oct. 10, 2024

(54) STATOR IRON CORE MANUFACTURING METHOD AND OUTER ROTOR MOTOR

(71) Applicant: AAC Acoustic Technologies (Shanghai) Co., Ltd., Shanghai (CN)

(72) Inventors: Chunjiang Li, Shanghai (CN); Bing Xie, Shanghai (CN); Liang Jiang, Shanghai (CN)

(21) Appl. No.: 18/399,802

(22) Filed: Dec. 29, 2023

Related U.S. Application Data
(63) Continuation of application No. PCT/CN2023/092628, filed on May 7, 2023.

(30) Foreign Application Priority Data
Apr. 10, 2023 (CN) 202310377459.2

(51) Int. Cl. H02K 15/02; H02K 1/14; H02K 15/085; H02K 15/12

(52) U.S. Cl. CPC H02K 15/026; H02K 1/148; H02K 15/085; H02K 15/12

(57) ABSTRACT

The disclosure discloses method that includes: step S1: manufacturing strip-shaped iron core; step S2: performing wire-winding around the wire-winding bodies with center line as axis to form stator winding; step S3: rolling strip-shaped iron core, on which winding has been performed through step S2, into outer ring with tooth portions as periphery, and connecting arc-shaped surfaces of all yoke portions to form inner ring, so that strip-shaped iron core has ring-shaped structure; step S4: machining tooth portions and yoke portions of strip-shaped iron core respectively, so that joints after strip-shaped iron core is rolled into circle are fixed to form stator iron core with integrated structure. The disclosure discloses outer rotor motor using the method. Compared with related art, by use of technical solutions of the disclosure, coils can be effectively wound neatly in wire slot, with high slot filling rate, simple process, and easy manufacturing.

### TECHNICAL FIELD

The present disclosure relates to the technical field of motors, and in particular, to a stator iron core manufacturing method and an outer rotor motor.

### BACKGROUND

At present, a motor is used more and more widely. An outer rotor motor has larger torque than an inner rotor motor, and is widely used especially in robots and drones. A stator iron core is an important component of the outer rotor motor.

In the related art, in the application of robots and drones, the outer rotor motor is powered by a low voltage. In the related art, a wire diameter of a coil wound around the stator iron core is relatively thick, and the coil is generally wound around the stator iron core by flying fork winding.

However, in the related art, the coil is wound around the stator iron core by flying fork winding, but flying fork winding makes it difficult to neatly insert thick wires into the wire slot and achieve a high slot filling rate. In addition, the structure of the stator iron core requires a complex manufacturing process and is difficult to implement.

Therefore, there is a need to provide a new method and a new motor to solve the above technical problems.

### SUMMARY

An objective of the present disclosure is to provide a stator iron core manufacturing method and an outer rotor motor that can effectively wind coils neatly in the wire slot, with a high slot filling rate, a simple process, and easy manufacturing, so as to overcome the above technical problems.

In order to achieve the above objective, in a first aspect, the present disclosure provides a stator iron core manufacturing method, applied to an outer rotor motor with a stator iron core, wherein the method includes the following steps:
step S1: manufacturing a strip-shaped iron core; the strip-shaped iron core including a plurality of strip-shaped punching sheets connected sequentially along a first direction, each of the strip-shaped punching sheets including a tooth portion extending along the first direction, a winding body protruding from one side of the tooth portion along a second direction, and a yoke portion extending from the winding body in a direction away from the tooth portion, all the wire-winding bodies being located on a same side of all the tooth portions, the tooth portions being sequentially connected into a long strip, each of the tooth portions being an arc segment, the tooth portions together forming a ring shape, joints between adjacent tooth portions being provided with force-reducing grooves, the force-reducing grooves being located on sides of the joints close to the wire-winding bodies, and a side of each of the yoke portions away from each of the tooth portions being a concave arc-shaped surface; each of the arc-shaped surfaces being a part for forming a same ring;
step S2: performing wire-winding around each of the wire-winding bodies with a center line as an axis to form a stator winding;
step S3: rolling the strip-shaped iron core, on which winding has been performed through step S2, into an integral outer ring with the tooth portions as a periphery, and connecting the arc-shaped surfaces of all the yoke portions to form an integral inner ring, so that the strip-shaped iron core has a ring-shaped structure; and
step S4: combining and fixing joints of the outer ring formed by rolling the tooth portions of the strip-shaped iron core, and combining and fixing joints of the inner ring formed by connecting the yoke portions, so that the strip-shaped iron core is rolled into the stator iron core having an integrated structure.

As an improvement, in step S1, the first direction and the second direction are perpendicular to each other.

As an improvement, in step S1, each of the wire-winding bodies includes a wire-winding body body and a wire slot formed by recessing the wire-winding body body in a direction of a center line parallel to the second direction, and the stator winding is wound in the wire slot.

As an improvement, in step S1, two opposite sides of each of the yoke portions along the first direction are respectively provided with a matching hole formed by recessing and a matching bump formed by protruding; and in step S3, when the arc-shaped surfaces are connected to form the inner ring, the matching bump of each of the yoke portions is engaged with the matching hole of the yoke portion adjacent thereto to form an entirety.

As an improvement, in step S3, all the wire-winding bodies are radially distributed with a ring center of the ring-shaped structure as a center, and the wire-winding bodies are arranged at equal intervals from each other.

As an improvement, step S4 includes the following substeps:
step S41: fixedly connecting the joint of the two tooth portions at head and tail ends of the strip-shaped iron core to form an entirety; and
step S42: fixedly connecting the joint of every two adjacent yoke portions of the strip-shaped iron core to form an entirety.

As an improvement, step S4 further includes step S43 in which cutting is performed at the joint between two adjacent tooth portions, so that each of the force-reducing grooves forms a fracture structure and the two adjacent tooth portions are spaced apart from each other.

As an improvement, subsequent to step S4, the stator iron core manufacturing method further includes: integrally reinforcing the stator iron core by injection molding.

As an improvement, subsequent to step S4, the stator iron core manufacturing method further includes:

providing a through hole in each of the yoke portions along an axial direction of the stator iron core, and arranging a ring-shaped reinforcing plate on an end face of the stator iron core, the reinforcing plate covering the end face of the stator iron core and being fixed through the through hole, so as to reinforce the stator iron core.

In a second aspect, the present disclosure further provides an outer rotor motor, wherein the outer rotor motor includes the stator iron core manufactured with the stator iron core manufacturing method as provided above in the present disclosure.

Compared with the related art, the stator iron core manufacturing method and the outer rotor motor of the present disclosure are both implemented through steps of the stator iron core manufacturing method. The stator iron core manufacturing method includes the following steps: manufacturing a strip-shaped iron core; performing wire-winding around each of the wire-winding bodies with a center line as an axis to form a stator winding; rolling the strip-shaped iron core, on which winding has been performed, into an outer ring with the tooth portions as a periphery, and connecting the arc-shaped surfaces of all the yoke portions to form an inner ring, so that the strip-shaped iron core has a ring-shaped structure; and combining and fixing joints of the outer ring formed by rolling the tooth portions of the strip-shaped iron core, and combining and fixing joints of the inner ring formed by connecting the yoke portions, so that the strip-shaped iron core is rolled into the stator iron core having an integrated structure. The strip-shaped iron core manufactured with the above method facilitates the winding to form the stator winding, so as to effectively wind coils neatly in the wire slot and achieve a high slot filling rate, and then the strip-shaped iron core is rolled into an entire ring-shaped structure to make the stator iron core. With the method, the stator iron core has a simple manufacturing process and is easy to manufacture, so that the stator iron core manufacturing method and the outer rotor motor in the present disclosure can effectively wind coils neatly in the wire slot, with a high slot filling rate, a simple process, and easy manufacturing.

### BRIEF DESCRIPTION OF DRAWINGS

In order to illustrate the technical solutions in the embodiments of the present disclosure more clearly, the accompanying drawings to be used in the description of the embodiments will be briefly introduced below. Obviously, the accompanying drawings in the following description are only some embodiments of the present disclosure. For those of ordinary skill in the art, other accompanying drawings can be obtained based on these drawings without creative efforts. In the drawings,

FIG. 1 is a flowchart block diagram of a stator iron core manufacturing method according to the present disclosure;

FIG. 2 is a schematic structural diagram of a strip-shaped iron core in step S1 of the stator iron core manufacturing method according to the present disclosure;

FIG. 3 is a schematic structural diagram of a strip-shaped punching sheet according to an embodiment of the present disclosure;

FIG. 4 is a schematic enlarged view of Part C in FIG. 2;

FIG. 5 is a schematic structural diagram of the strip-shaped iron core with a stator winding machined in step S2 of the stator iron core manufacturing method according to the present disclosure;

FIG. 6 is a schematic structural diagram of the strip-shaped iron core machined in step S3 of the stator iron core manufacturing method according to the present disclosure;

FIG. 7 is a schematic structural diagram of a stator iron core machined in step S4 of the stator iron core manufacturing method according to the present disclosure; and

FIG. 8 is a schematic structural diagram of the stator iron core machined in step S4 of the stator iron core manufacturing method according to another embodiment of the present disclosure.

### DESCRIPTION OF EMBODIMENTS

The technical solutions in the embodiments of the present disclosure will be clearly and completely described below with reference to the accompanying drawings in the embodiments of the present disclosure. Obviously, the described embodiments are only some of the embodiments of the present disclosure, but not all of the embodiments. Based on the embodiments of the present disclosure, all other embodiments obtained by those of ordinary skill in the art without creative efforts fall within the protection scope of the present disclosure.

The present disclosure provides a stator iron core manufacturing method. The stator iron core manufacturing method is applied to an outer rotor motor with a stator iron core.

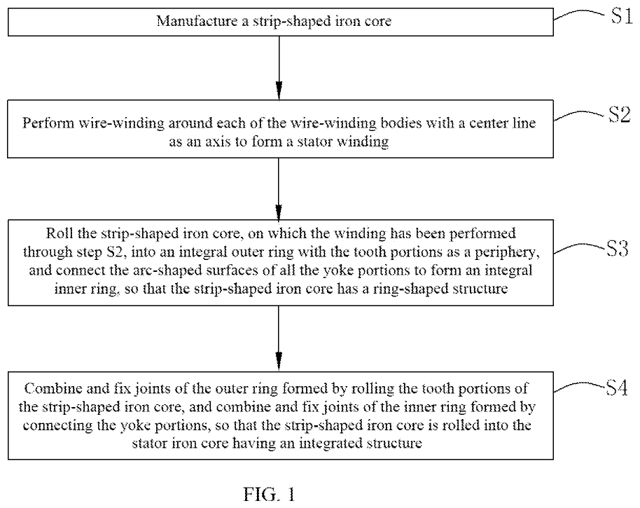

Referring to FIG. 1, specifically, the stator iron core manufacturing method includes the following steps.

In step S1, a strip-shaped iron core 100 is manufactured.

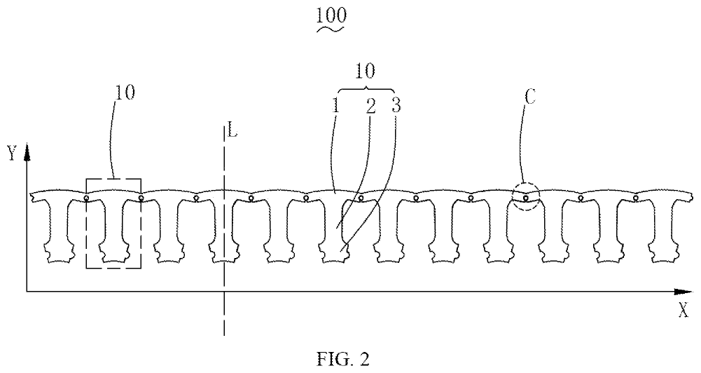

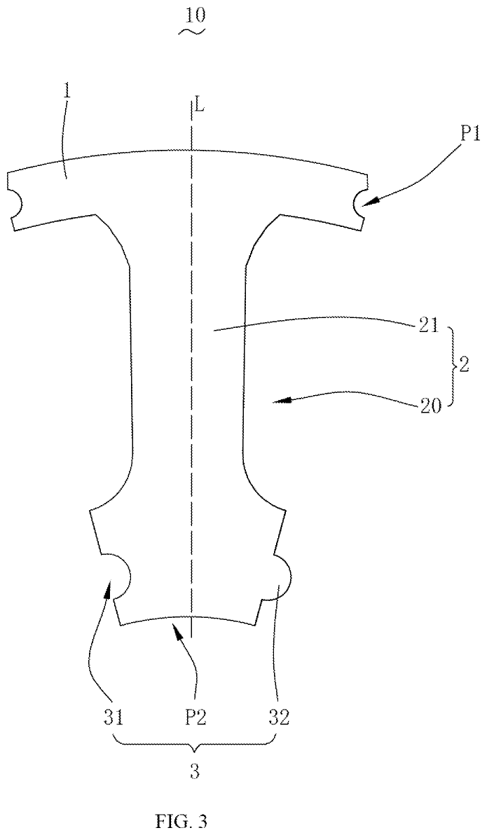

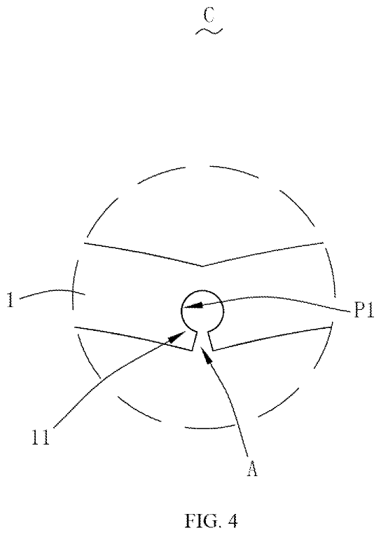

Referring to FIG. 2 to FIG. 4 together, the strip-shaped iron core 100 has the following structure.

The strip-shaped iron core 100 includes a plurality of strip-shaped punching sheets 10 connected sequentially along a first direction X.

In this embodiment, the strip-shaped punching sheets 10 are made of iron.

Specifically, each of the strip-shaped punching sheets 10 includes a tooth portion 1 sequentially arranged along the first direction X, a winding body 2 protruding from one side of the tooth portion 1 along a second direction Y, and a yoke portion 3 extending from the winding body 2 in a direction away from the tooth portion 1.

In this embodiment, the first direction X and the second direction Y are perpendicular to each other.

The tooth portions 1 are sequentially connected into a long strip, and each of the tooth portions 1 is an arc segment. All the tooth portions 1 together form a ring shape. It is to be noted that the tooth portions 1 which are arc segments may all be arc segments for forming a same circle or non-concentric arc segments. Either is feasible as long as the tooth portions can form a ring shape together.

Joints between adjacent tooth portions 1 are provided with force-reducing grooves 11. The force-reducing grooves 11 are located on sides of the joints close to the wire-winding bodies 2. The arrangement of the force-reducing grooves 11 can make it easier to roll the tooth portions connected into a long strip into a ring shape. That is, the joint between two adjacent tooth portions 1 is thinned so that the position is close to a fracture structure to block passage of a magnetic line of force, making it easier for the magnetic line of force at this position to saturate. Therefore, the shape of the force-reducing groove 11 is not limited, which may be a concave elongated groove, a concave arc-shaped groove, or the like. In this implementation, the force-reducing groove 11 is formed by a concave arc P1 and a notch A. Specifically, two ends of each of the tooth portions 1 along the first direction X and the joint between the two tooth portions 1 adjacent thereto are each provided with an inwardly concave arc P1. The two arcs P1 at the joint between two adjacent tooth portions 1 together form a circle with the notch A. The notch A is located on a side of the joint close to the winding body 2. Certainly, the structure of the force-reducing groove 11 is not limited to the above implementation.

All the wire-winding bodies 2 are located on a same side of all the tooth portions 1.

Each of the wire-winding bodies 2 includes a wire-winding body body 21 and a wire slot 20 formed by recessing the wire-winding body body 21 in a direction of a center line L parallel to the second direction Y. The stator winding 4 is wound in the wire slot 20. On the basis that the tooth portions 1 are sequentially connected into a long strip, machining and winding are performed in the wire slot 20, which can effectively wind coils neatly in the wire slot 20 and achieve a high slot filling rate.

In this implementation, a side of each of the yoke portions 3 away from each of the tooth portions 1 is a concave arc-shaped surface P2. Each of the arc-shaped surfaces P2 is a part for forming a same ring, but is not limited to forming a same circle.

Two opposite sides of each of the yoke portions 3 along the first direction X are respectively provided with a matching hole 31 formed by recessing and a matching bump 32 formed by protruding. A shape of the matching hole 31 of each yoke portion 3 matches a shape of the matching bump 32 of one yoke portion 3 adjacent thereto.

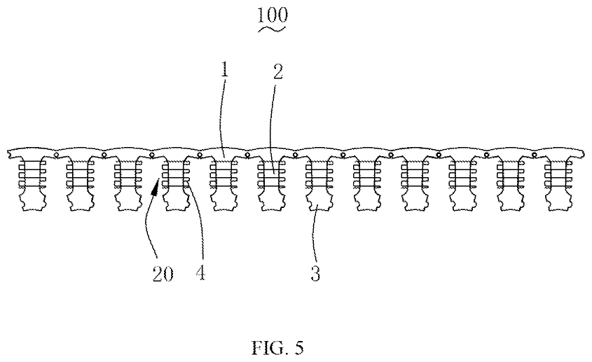

In step S2, winding is performed around each of the wire-winding bodies 2 with a center line L as an axis to form a stator winding 4. Referring to FIG. 5, the stator winding 4, on which the winding has been performed through step S2, has a simple process and a high slot filling rate.

In step S3, the strip-shaped iron core 100, on which the winding has been performed through step S2, is rolled into an integral outer ring with the tooth portions 1 as a periphery, and the arc-shaped surfaces P2 of all the yoke portions 3 are connected to form an integral inner ring, so that the strip-shaped iron core 100 has a ring-shaped structure. In this step, the outer ring may be circular or non-circular, and the inner ring may be a circle concentric with an outer circle or non-circular.

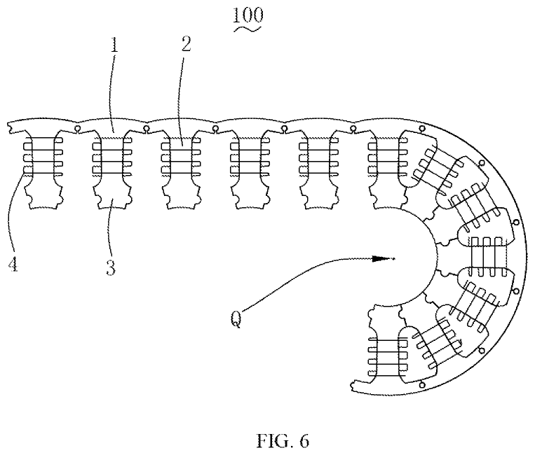

Specifically, in step S3, when the arc-shaped surfaces P2 are connected to form the inner ring, the matching bump 32 of each of the yoke portions 3 is engaged with the matching hole 21 of the yoke portion 3 adjacent thereto to form an entirety. Referring to FIG. 6, as an improvement, all the wire-winding bodies 2 are radially distributed with a ring center Q of the ring-shaped structure as a center. The wire-winding bodies 2 are arranged at equal intervals from each other. Certainly, the wire-winding bodies 2 may also be arranged at equal intervals, which is feasible.

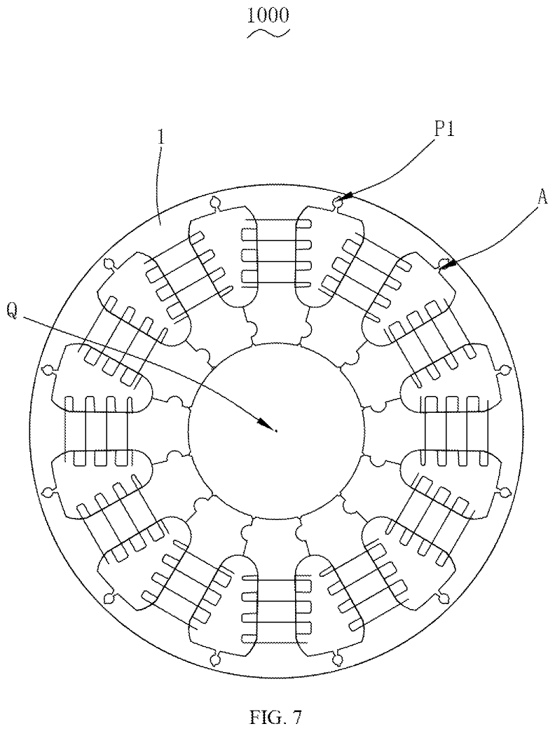

In step S4, joints of the outer ring formed by rolling the tooth portions 1 of the strip-shaped iron core 100 are combined and fixed, and joints of the inner ring formed by connecting the yoke portions 3 are combined and fixed, so that the strip-shaped iron core 100 is rolled into the stator iron core 1000 having an integrated structure, as shown in FIG. 7.

In this implementation, step S4 specifically includes the following substeps.

In step S41, the joint of the two tooth portions 1 at head and tail ends of the strip-shaped iron core 100 is fixedly connected to form an entirety.

In step S42, the joint of every two adjacent yoke portions 3 of the strip-shaped iron core 100 is fixedly connected to form an entirety, thereby obtaining the stator iron core 1000 having an integrated structure. In this step, connection and fixation are achieved by engaging the matching bumps 32 and the matching holes 31 on the two adjacent yoke portions 3 with each other.

The stator iron core 1000 obtained with the above method has an integral periphery, and thus has a stronger structure. However, since the position of the force-reducing groove 11 between adjacent tooth portions 1 is still a connected entirety, it is equivalent to thinning the joint between two adjacent tooth portions 1. If there is still a phenomenon of cross magnetization at the joint, a small number of magnetic lines of force cannot flow to an outer rotor, thereby weakening magnetic field performance.

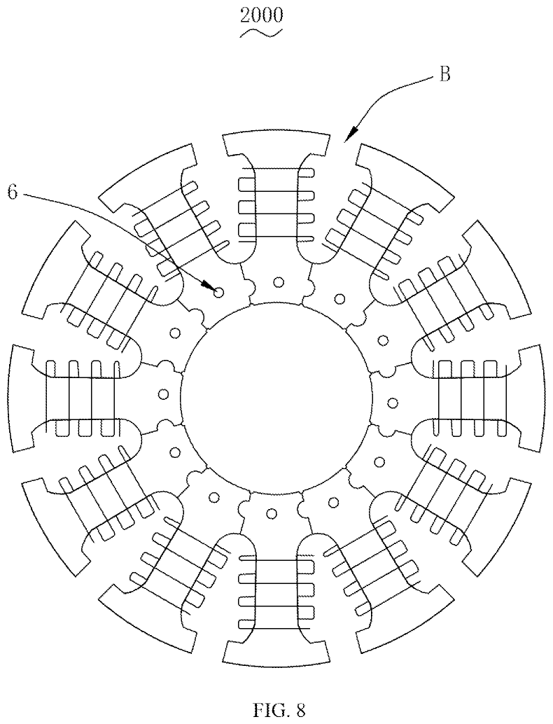

Therefore, as an improvement, the method of the present disclosure may be further optimized. As shown in FIG. 8, the method further includes step S43 in which cutting is performed at the joint between two adjacent tooth portions 1, so that each of the force-reducing grooves 11 forms a fracture structure B and the two adjacent tooth portions 1 are spaced apart from each other, to obtain a stator iron core 2000. The stator iron core 2000 effectively prevents a phenomenon of magnetic resistance, so that magnetic lines of force of the stator winding 4 may all flow to the outer rotor, and the magnetic field performance is better.

In order to enhance structural strength of the stator iron core 1000 in the embodiments of the present disclosure or the stator iron core 2000 in another embodiment, in particular, to enhance the structural strength of the stator iron core 2000, in this implementation, the stator iron core is integrally reinforced by injection molding or plastic sealing. Certainly, the present disclosure is not limited to this manner. Alternatively, a through hole 6 may be provided in each of the yoke portions 3 along an axial direction of the stator iron core, a ring-shaped reinforcing plate (not shown) is arranged on an end face of the stator iron core, the reinforcing plate covers the end face of the stator iron core and is fixed through the through hole 6, so as to reinforce the stator iron core, which is also feasible.

An embodiment of the present disclosure further provides an outer rotor motor. The outer rotor motor includes the stator iron core 1000 or stator iron core 2000 manufactured with the stator iron core manufacturing method.

The outer rotor motor provided in this embodiment of the present disclosure can realize various implementations in the embodiments of the stator iron core manufacturing method, as well as corresponding beneficial effects. To avoid repetition, details are not described again herein.

This implementation mentioned in the embodiments of the present disclosure is to facilitate the description. The above disclosure is only preferred embodiments of the present disclosure, which certainly cannot be used to limit the scope of the present disclosure. Therefore, equivalent changes made according to the claims of the present disclosure still fall within the scope of the present disclosure.

Compared with the related art, the stator iron core manufacturing method and the outer rotor motor of the present disclosure are both implemented through steps of the stator iron core manufacturing method. The stator iron core manufacturing method includes the following steps: manufacturing a strip-shaped iron core; performing wire-winding around each of the wire-winding bodies with a center line as an axis to form a stator winding; rolling the strip-shaped iron core, on which winding has been performed, into an outer ring with the tooth portions as a periphery, and connecting the arc-shaped surfaces of all the yoke portions to form an inner ring, so that the strip-shaped iron core has a ring-shaped structure; and combining and fixing joints of the outer ring formed by rolling the tooth portions of the strip-shaped iron core, and combining and fixing joints of the inner ring formed by connecting the yoke portions, so that the strip-shaped iron core is rolled into the stator iron core having an integrated structure. The strip-shaped iron core manufactured with the above method facilitates the winding to form the stator winding, so as to effectively wind coils neatly in the wire slot and achieve a high slot filling rate, and then the strip-shaped iron core is rolled into an entire ring-shaped structure to make the stator iron core. With the method, the stator iron core has a simple manufacturing process and is easy to manufacture, so that the stator iron core manufacturing method and the outer rotor motor in the present disclosure can effectively wind coils neatly in the wire slot, with a high slot filling rate, a simple process, and easy manufacturing.

The above are only embodiments of the present disclosure and not thus intended to limit the patent scope of the present disclosure. All equivalent structures or equivalent flow transformations made by virtue of contents of the specification and the drawings of the present disclosure or direct or indirect application of the contents to the other related technical fields shall fall within the patent protection scope of the present disclosure.

What is claimed is:

1. A method for manufacturing a stator iron core for an outer rotor motor with a stator iron core, comprising:
step S1: manufacturing a strip-shaped iron core; wherein the strip-shaped iron core comprises strip-shaped punching sheets connected sequentially along a first direction, each of the strip-shaped punching sheets comprises a tooth portion extending along the first direction, a winding body protruding from one side of the tooth portion along a second direction, and a yoke portion extending from the winding body in a direction away from the tooth portion, the wire-winding bodies are all located on a same side of all the tooth portions, the tooth portions are sequentially connected into a long strip, each of the tooth portions is an arc segment, and together encloses a ring shape, joints between adjacent tooth portions are provided with force-reducing grooves, the force-reducing grooves are located on sides of the joints close to the wire-winding bodies, and a side of each of the yoke portions away from each of the tooth portions is a concave arc-shaped surface; each of the arc-shaped surfaces is a part for forming a same ring;
step S2: performing wire-winding around each of the wire-winding bodies with a center line as an axis to form a stator winding;
step S3: rolling the strip-shaped iron core, on which the wire-winding has been performed in step S2, into an integral outer ring with the tooth portions as a periphery, and connecting the arc-shaped surfaces of all the yoke portions to form an integral inner ring, so that the strip-shaped iron core has a ring-shaped structure; and
step S4: combining and fixing joints of the outer ring formed by rolling the tooth portions of the strip-shaped iron core, and combining and fixing joints of the inner ring formed by connecting the yoke portions, so that the strip-shaped iron core is rolled into the stator iron core having an integrated structure.

2. The method as described in claim 1, wherein, in step S1, the first direction and the second direction are perpendicular to each other.

3. The method as described in claim 1, wherein, in step S1, each of the wire-winding bodies comprises a wire-winding body body and a wire slot formed by recessing the wire-winding body body in a direction of a center line parallel to the second direction, and the stator winding is wound in the wire slot.

4. The method as described in claim 1, wherein, in step S1, two opposite sides of each of the yoke portions along the first direction are respectively provided with a matching hole formed by recessing and a matching bump formed by protruding; and
in step S3, when the arc-shaped surfaces are connected to form the inner ring, the matching bump of each of the yoke portions is engaged with a matching hole of a yoke portion adjacent to the each of the yoke portions to form an entirety.

5. The method as described in claim 1, wherein, in step S3, all the wire-winding bodies are radially distributed with a ring center of the ring-shaped structure as a center, and the wire-winding bodies are arranged at equal intervals from each other.

6. The method as described in claim 1, wherein step S4 comprises following sub-steps:
step S41: fixedly connecting joints of the two tooth portions at a head end and tail end of the strip-shaped iron core to form an entirety; and
step S42: fixedly connecting joints of every two adjacent yoke portions of the strip-shaped iron core to form an entirety.

7. The method as described in claim 6, wherein step S4 further comprises step S43 in which cutting is performed at a joint between two adjacent tooth portions, so that each of the force-reducing grooves forms a fracture structure and the two adjacent tooth portions are spaced apart from each other.

8. The method as described in claim 1, wherein, subsequent to step S4, the method further comprises:
integrally reinforcing the stator iron core by injection molding.

9. The method as described in claim 1, wherein, subsequent to step S4, the method further comprises:
providing a through hole on each of the yoke portions along an axial direction of the stator iron core, and arranging a ring-shaped reinforcing plate on an end face of the stator iron core, wherein the reinforcing plate covers the end face of the stator iron core and is fixed through the through hole, so as to reinforce the stator iron core.

10. An outer rotor motor, wherein the outer rotor motor comprises the stator iron core manufactured by the method as described in claim 1.
